(19) United States
(12) Patent Application Publication
(10) Pub. No.: US 2024/0230697 A1
(43) Pub. Date: Jul. 11, 2024

(54) SLIDE INFORMATION CAPTURING AND EVALUATION DEVICE AND METHOD OF OPERATING THE SAME

(71) Applicant: SONG YI SYSTEM CO., LTD., Hsinchu County (TW)

(72) Inventors: Chun-Chieh CHIANG, Hsinchu County (TW); Li-Ling CHANG, Hsinchu County (TW)

(21) Appl. No.: 18/457,364

(22) Filed: Aug. 29, 2023

Related U.S. Application Data
(60) Provisional application No. 63/478,503, filed on Jan. 5, 2023.

(51) Int. Cl. G01N 35/00

(52) U.S. Cl. CPC G01N 35/0099; G01N 35/00029; G01N 35/00623; G01N 2035/00039; G01N 2035/00891

(57) ABSTRACT

A method of operating a slide information capturing and evaluation device includes receiving a slide in a first region of a slide cassette device. The slide is moved out of the first region of the slide cassette device and the slide is placed on an alignment device by a robotic arm. The slide is moved out of the alignment device and the slide is placed on an image capturing device by the robotic arm. An image of a sample distribution area of the slide is captured by the image capturing device. The slide is determined whether in a defective state based on the image captured by the image capturing device.

### CROSS-REFERENCE TO RELATED APPLICATION

This application claims priority to U.S. Provisional Application Ser. No. 63/478,503, filed Jan. 5, 2023, which is herein incorporated by reference in its entirety.

### BACKGROUND

### Technical Field

The present disclosure relates to a slide information capturing and evaluation device and a method of operating the slide information capturing and evaluation device.

### Description of Related Art

Pathological examination is a histopathological method used to examine pathological changes in cytology or tissues. In order to investigate the disease process occurring in the cytology or tissues, an examination method of histopathology can be used to examine lesions and investigate causes, pathogenesis, and a development process of the aforementioned lesions, ultimately leading to a pathological diagnosis. The examination method of histopathology includes observing the pathological changes in gross specimens, obtaining a certain size of the diseased tissue, preparing pathological slides using a histological technique, and analyzing the slides (e.g., determining the presence of the lesions).

However, multiple pathological slides may contain defective slides, leading to inaccuracies in pathological examination. Therefore, a problem of the defective slides in the pathological slides is one of the targets in the research and development in the related fields.

### SUMMARY

One aspect of the present disclosure is a method of operating a slide information capturing and evaluation device.

According to some embodiments of the present disclosure, a method of operating a slide information capturing and evaluation device includes receiving a slide in a first region of a slide cassette device. The slide is moved out of the first region of the slide cassette device and the slide is placed on an alignment device by a robotic arm. The slide is moved out of the alignment device and the slide is placed on an image capturing device by the robotic arm. An image of a sample distribution area of the slide is captured by the image capturing device. The slide is determined whether in a defective state based on the image captured by the image capturing device.

In some embodiments, the method of operating the slide information capturing and evaluation device further includes placing the slide in a second region of the slide cassette device different from the first region if the slide by the robotic arm is determined to be in the defective state.

In some embodiments, the method of operating the slide information capturing and evaluation device further includes prior to placing the slide in the second region of the slide cassette device, moving the slide out of the image capturing device and placing the slide on the alignment device by the robotic arm.

In some embodiments, the method of operating the slide information capturing and evaluation device further includes placing the slide in the first region of the slide cassette device by the robotic arm if the slide is determined not to be in the defective state.

In some embodiments, the method of operating the slide information capturing and evaluation device further includes prior to placing the slide in the first region of the slide cassette device by the robotic arm, moving the slide out of the image capturing device and placing the slide on the alignment device by the robotic arm.

In some embodiments, determining whether the slide is in the defective state includes analyzing the image captured by the image capturing device to calculate a sample indicator value. The sample indicator value is compared with a predetermined indicator value, in which if the sample indicator value is smaller than the predetermined indicator value, the slide is determined to be in the defective state, and if the sample indicator value is greater than or equal to the predetermined indicator value, the slide is determined not to be in the defective state.

In some embodiments, the image capturing device includes a support element, the support element has an accommodation space, and the alignment device is located in the accommodation space of the support element of the image capturing device.

Another aspect of the present disclosure is a method of operating a slide information capturing and evaluation device.

According to some embodiments of the present disclosure, a method of operating a slide information capturing and evaluation device includes receiving a slide in a first region of a slide cassette device. The slide is placed by a robotic arm on an image capturing device. An image of a sample distribution area of the slide is captured by the image capturing device. The slide is determined whether in a defective state based on the image captured by the image capturing device. The slide is placed by the robotic arm in the first region of the slide cassette device if the slide is determined not to be in the defective state, and the slide is placed by the robotic arm in a second region of the slide cassette device different from the first region if the slide is determined to be in the defective state.

In some embodiments, the method of operating the slide information capturing and evaluation device further includes placing the slide on an alignment device by the robotic arm such that a protrusion portion of a slide holder and positioning pillars of the alignment device are respectively against two opposite sides of the slide.

In some embodiments, placing the slide on the alignment device is performed prior to placing the slide on the image capturing device.

In some embodiments, placing the slide on the alignment device is performed after placing the slide on the image capturing device.

In some embodiments, the method of operating the slide information capturing and evaluation device further includes issuing a warning message if the slide is determined to be in the defective state.

In some embodiments, the method of operating the slide information capturing and evaluation device further includes capturing an image of an identification area of the slide by the image capturing device.

Another aspect of the present disclosure is a slide information capturing and evaluation device.

According to some embodiments of the present disclosure, a slide information capturing and evaluation device includes a slide cassette device, a scanning assembly device, a processor and a mechanical device. The slide cassette device is configured to receive a slide in a first region of the slide cassette device. The scanning assembly device includes an image capturing device adjacent to the slide cassette device, in which the image capturing device is configured to capture an image of a sample distribution area of the slide. The processor is communicatively connected to the image capturing device of the scanning assembly device and configured to determine whether the slide is in a defective state based on the image captured by the image capturing device. The mechanical device is communicatively connected to the processor, in which the mechanical device includes a robotic arm configured to move the slide from the slide cassette device to the image capturing device.

In some embodiments, the slide information capturing and evaluation device further includes an alignment device disposed in an accommodation space of a support element of the image capturing device of the scanning assembly device and configured to position the slide prior to capturing the image of the sample distribution area of the slide.

In some embodiments, the alignment device is further configured to position the slide after capturing the image of the sample distribution area of the slide.

In some embodiments, the alignment device includes a slide holder and a positioning pillar, and a protrusion portion of the slide holder and the positioning pillar are respectively against two opposite sides of the slide.

In some embodiments, the robotic arm is configured to place the slide in a second region of the slide cassette device different from the first region if the slide is determined to be in the defective state.

In some embodiments, the robotic arm is configured to place the slide in the first region of the slide cassette device if the slide is determined not to be in the defective state.

In some embodiments, the robotic arm includes a slide holder and a detector disposed on the slide holder, the slide holder of the robotic arm is configured to hold the slide, and the detector is configured to detect a location of the slide in the slide cassette device.

In the aforementioned embodiments, since the image capturing device of the slide information capturing and evaluation device is configured to capture the image of the sample distribution area of the slide, and the processor is configured to determine whether the slide is in the defective state based on the image captured by the image capturing device, it is beneficial to categorize the slide in the defective state and not in the defective state before performing subsequent pathological examination (e.g., analysis procedures using an optical device). Therefore, the slide information capturing and evaluation device of the present disclosure can transfer the physical slide (the slide in a physical state) into digital information (the slide in a digital state) and effectively improve the accuracy of the subsequent pathological examination.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic view of a slide information capturing and evaluation device in accordance with an embodiment of the present disclosure.

FIG. 2 is a schematic view of the slide information capturing and evaluation device without an outer housing in accordance with an embodiment of the present disclosure.

FIG. 3 is a functional block view of the slide information capturing and evaluation device in accordance with an embodiment of the present disclosure.

FIG. 4 is a schematic view of a slide cassette device in accordance with an embodiment of the present disclosure.

FIG. 5 is a front view of the slide cassette device in FIG. 4.

FIG. 6 is a schematic view of a slide in the slide cassette device in FIG. 4.

FIG. 7 is a schematic view of an alignment device in accordance with an embodiment of the present disclosure.

FIG. 8 is a schematic view of a scanning assembly device in accordance with an embodiment of the present disclosure.

FIG. 9 is a schematic view of an image capturing device and a slide compression device of the scanning assembly device in FIG. 8.

FIG. 10 is a schematic view of a planar base and the slide compression device of the scanning assembly device in FIG. 8.

FIG. 11 is a schematic view of an optical device of the scanning assembly device in FIG. 8.

FIG. 12 is a front view of the optical device of the scanning assembly device in FIG. 11.

FIG. 13 is a front view of the optical device including a second light source in accordance with an embodiment of the present disclosure.

FIG. 14 is a schematic view of a mechanical device in accordance with an embodiment of the present disclosure.

FIG. 15 is a partially enlarged view of a robotic arm of the mechanical device in FIG. 14.

FIG. 16 is a flowchart of a method of operating a slide information capturing and evaluation device in accordance with an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

As used herein, “around,” “about,” “approximately,” or “substantially” shall generally mean within 20 percent, or within 10 percent, or within 5 percent of a given value or range. Numerical quantities given herein are approximate, meaning that the term “around,” “about,” “approximately,” or “substantially” can be inferred if not expressly stated.

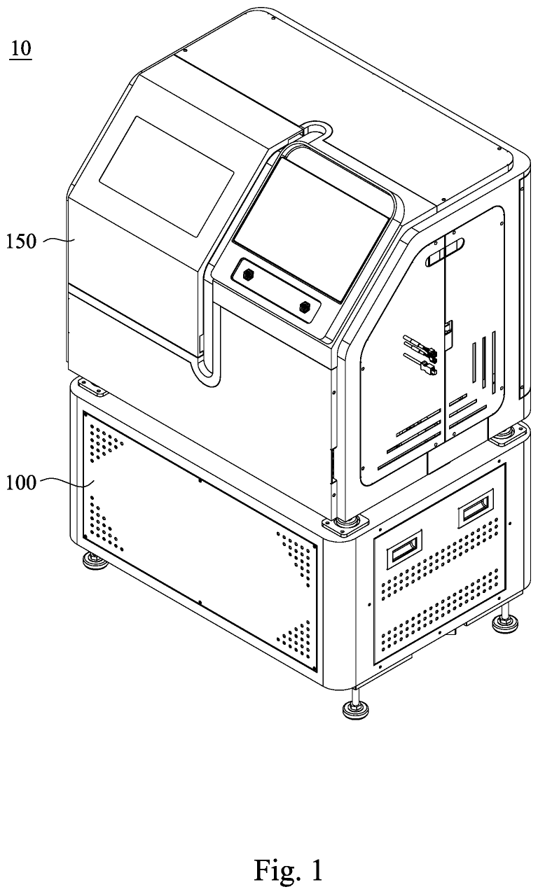

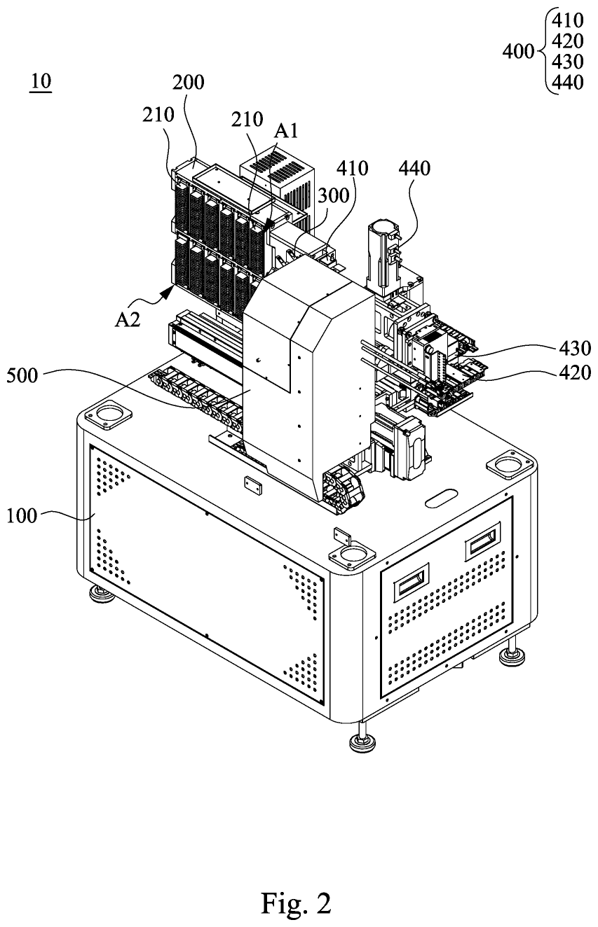

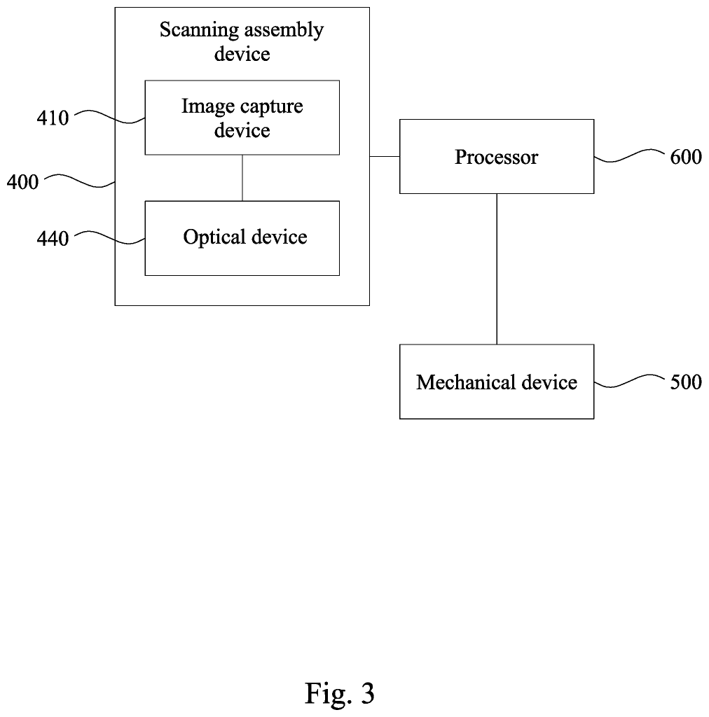

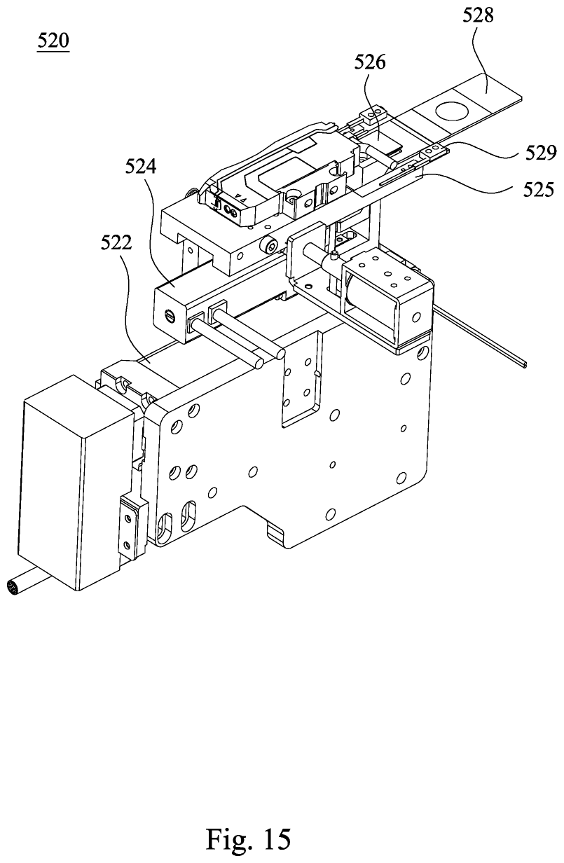

FIG. 1 is a schematic view of a slide information capturing and evaluation device 10 in accordance with an embodiment of the present disclosure, FIG. 2 is a schematic view of the slide information capturing and evaluation device 10 without an outer housing 150 in accordance with an embodiment of the present disclosure, and FIG. 3 is a functional block view of the slide information capturing and evaluation device 10 in accordance with an embodiment of the present disclosure. It is noted that FIG. 3 merely illustrates electrical relationships among a scanning assembly device 400, a mechanical device 500, and a processor 600 of the slide information capturing and evaluation device 10, and other components of the slide information capturing and evaluation device 10 are omitted in FIG. 3 and illustrated in FIGS. 1 and 2 for the sake of clear and simplicity. Referring to FIGS. 1 to 3, the slide information capturing and evaluation device 10 includes a workstation 100, an outer housing 150, a slide cassette device 200, an alignment device 300, a scanning assembly device 400, a mechanical device 500, and a processor 600. The slide cassette device 200, the alignment device 300, the scanning assembly device 400, and the mechanical device 500 are located on the workstation 100. The outer housing 150 is located outside (or externally to) and surrounds the slide cassette device 200, the alignment device 300, the scanning assembly device 400, and the mechanical device 500. The slide cassette device 200 is configured to receive slides 210 in a first region A1 of the slide cassette device 200. The scanning assembly device 400 includes an image capturing device 410, a planar base 420, a slide compression device 430 and an optical device 440. The image capturing device 410 is adjacent to the slide cassette device 200 and is configured to capture an image of a sample distribution area of the slide 210 (see the sample distribution area 212 in FIG. 5). The planar base 420 is located on the workstation 100. The slide compression device 430 is located on the planar base 420 and is configured to compress the slide 210 to facilitate operations by the optical device 440. The processor 600 is communicatively connected to the image capturing device 410 of the scanning assembly device 400 and the mechanical device 500, and the processor 600 is configured to determine whether the slide 210 is in a defective state based on the image captured by the image capturing device 410. The mechanical device 500 is communicatively connected to the processor 600, and the mechanical device 500 is configured to grip and place the slide 210. The mechanical device 500 is referred as a transfer station and moves among the slide cassette device 200, the alignment device 300 and the scanning assembly device 400. The mechanical device 500 includes a robotic arm (see the robotic arm 520 in FIG. 15) configured to move the slide 210 from the slide cassette device 200 to the image capturing device 410 (or from the image capturing device 410 to the slide cassette device 200). Since the image capturing device 410 is configured to capture the image of the sample distribution area (see the sample distribution area 212 in FIG. 5) of the slide 210, and the processor 600 is configured to determine whether the slide 210 is in the defective state based on the captured image, it is beneficial to categorize the slide 210 in the defective state and not in the defective state before performing subsequent pathological examination (e.g., analysis procedures of the slide 210 by using the optical device 440). Therefore, the slide information capturing and evaluation device 10 of the present disclosure can transfer the physical slide 210 into digital information and perform the evaluation of the slide 210 (e.g., determining whether the slide 210 is in the defective state), thereby effectively improving the accuracy of the subsequent pathological examination.

In some embodiments, the alignment device 300 is located between the slide cassette device 200 and the scanning assembly device 400. The alignment device 300 is configured to position the slide 210 prior to capturing the image of the sample distribution area (see the sample distribution area 212 in FIG. 5). In some embodiments, the alignment device 300 is further configured to position the slide 210 after capturing the image. It is noted that the “position” herein means that the alignment device 300 can secure (or fix) at least one side of the slide 210 to prevent the slide 210 from dropping when the slide 210 is gripped by the robotic arm (see the robotic arm 520 in FIG. 15). In some embodiments, the processor 600 is a central processing unit (CPU), a controller, or other analytical devices with analysis capabilities.

The slide cassette device 200, the alignment device 300, the scanning assembly device 400, and the mechanical device 500 of the slide information capturing and evaluation device 10 will be described in detail in the following paragraphs.

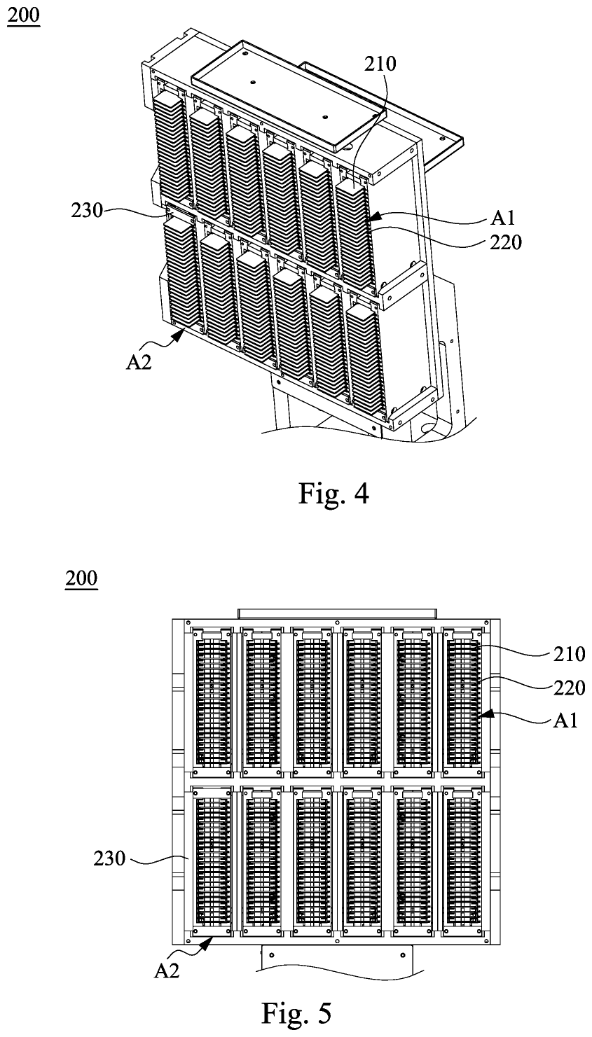

FIG. 4 is a schematic view of the slide cassette device 200 in accordance with an embodiment of the present disclosure, and FIG. 5 is a front view of the slide cassette device 200 in FIG. 4. Referring to FIGS. 2 to 5, the slide cassette device 200 is configured to receive the slides 210 in the first region A1 of the slide cassette device 200. In greater details, the slide cassette device 200 includes a plurality of slide cassettes 220 and at least one slide cassette 230, in which the slide cassettes 220 are located in the first region A1 of the slide cassette device 200, and the slide cassettes 230 are located in the second region A2 of the slide cassette device 200. The slide cassettes 220 in the first region A1 of the slide cassette device 200 are configured to receive the slides 210 that are not detected (e.g., captured and evaluated). After the slides 210 are detected (e.g., captured and evaluated), the slides 210 may be determined whether in the defective state. If the slides 210 are not in the defective state, the slides 210 are placed back into the first region A1 of the slide cassette device 200. For example, the slides 210 are placed back to the same location of the same slide cassette 220. If the slides 210 are in the defective state, the slides 210 are placed in the second region A2 of the slide cassette device 200 different from the first region A1 of the slide cassette device 200. For example, the slides 210 are placed in the slide cassette 230. In other words, the slide cassettes 230 are configured to receive the slides 210 that are detected and are determined to be in the defective state. Therefore, the slide cassette device 200 is beneficial to categorize the slides 210 into the defective state and not the defective state, thereby effectively improving the accuracy of subsequent pathological examination.

In some embodiments, one of the slide cassettes 220 in the slide cassette device 200 is designated as a priority slide cassette. For example, one of the slide cassettes 220 in the first region A1 of the slide cassette device 200 (e.g., the slide cassette 220 on the upper right hand side in FIG. 5) can be defined as the priority slide cassette. The slides 210 placed in the priority slide cassette are given priority in subsequent capturing and evaluating procedures (i.e., capturing an image of the sample distribution area 212 of the slide 210 by using the image capturing device 410 and determining whether the slide 210 is in the defective state by using the processor 600). In some embodiments, each of the slide cassettes 220 and/or the slide cassette 230 can receive or carrier multiple slides 210 (e.g., 25 slides). In some embodiments, the number of the slide cassettes 220 in the first region A1 is greater than the number of the slide cassettes 230 in the second region A2.

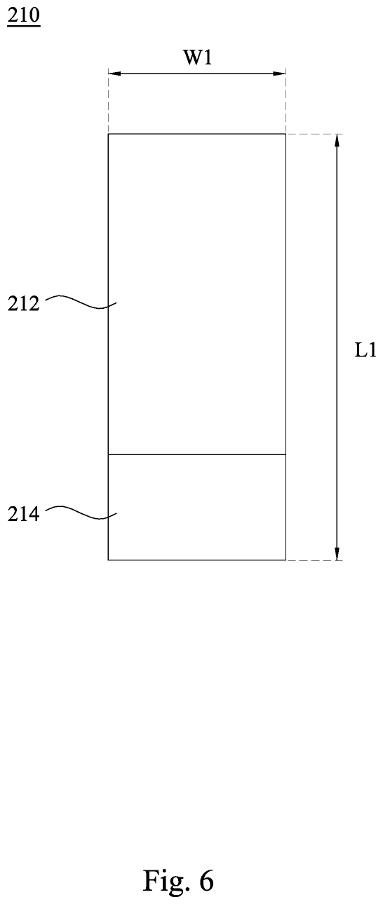

In some embodiments, FIG. 6 is a schematic view of the slide 210 in the slide cassette device 200 in FIG. 4. As shown in FIGS. 2 to 6, the slide 210 includes a sample distribution area 212 and an identification area 214. The sample distribution area 212 of the slide 210 is the area where cytology or tissues are placed, and the identification area 214 of the slide 210 is the area where identification information (e.g., identification code) of the slide 210 is set. In some embodiments, the slide 210 has a length L1 in a range from about 70 millimeters to about 80 millimeters (e.g., 75 millimeters or 76 millimeters) and a width W1 in a range from about 20 millimeters to about 30 millimeters (e.g., 25 millimeters or 26 millimeters). The slide 210 may have a thickness in a range from about 0.5 millimeters to about 1.5 millimeters (e.g., 0.9 millimeters, 1 millimeter, or 1.1 millimeters). In some embodiments, a slide cover is placed on the slide 210, in which a length, a width, and a thickness of the slide cover are respectively smaller than the length L1, the width W1, and the thickness of the slide 210. For example, the length of the slide cover is not greater than 50 millimeters, the width of the slide cover is not greater than 24 millimeters, and the thickness of the slide cover is in a range from about 0.13 millimeters to about 0.19 millimeters.

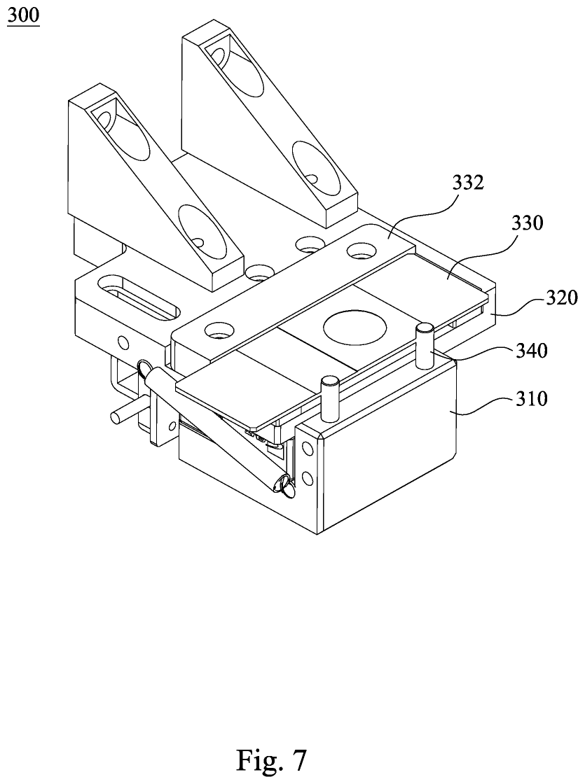

FIG. 7 is a schematic view of the alignment device 300 in accordance with an embodiment of the present disclosure. Referring to FIGS. 2, 6, and 7, the alignment device 300 is located between the slide cassette device 200 and the image capturing device 410. In some embodiments, the alignment device 300 is configured to position the slide 210 (or guide the location of the slide 210) prior to capturing the image of the sample distribution area 212. In some embodiments, the alignment device 300 is configured to position the slide 210 (or guide the location of the slide 210) after capturing the image of the sample distribution area 212. It is noted that the “position” herein means that the alignment device 300 can secure (or fix) at least one side of the slide 210 to prevent the slide 210 from dropping when the slide 210 is gripped by the robotic arm (see the robotic arm 520 in FIG. 15). In greater details, the alignment device 300 includes a base 310, a platform 320, a slide holder 330, and positioning pillars 340. The platform 320 is located on the base 310. The slide holder 330 is placed in a recess of the platform 320 and the slide holder 330 is configured to hold the slide 210. The positioning pillars 340 are located on the base 310 and the positioning pillars 340 are configured to secure (or position) the slide 210. In some embodiments, the positioning pillars 340 and a protrusion portion 332 of the slide holder 330 are respectively directly against (or contacts) two opposite sides of the slide 210 in order to secure the slide 210. Therefore, when the mechanical device 500 (e.g., the robotic arm 520 of the mechanical device 500) grips the slide 210, the mechanical device 500 (e.g., the robotic arm 520 of the mechanical device 500) can grip the slide 210 at a middle position (or a center) rather than at an edge position so as to avoid the slide 210 dropping before placing it on the image capturing device 410. For example, when gripping the slide 210 in the slide cassette device 200, the mechanical device 500 (e.g., the robotic arm 520 of the mechanical device 500) can grip the edge of the slide 210 (e.g., the shorter side of the slide 210); when gripping the slide 210 on the alignment device 300, the mechanical device 500 (e.g., the robotic arm 520 of the mechanical device 500) can grip the middle position (or the center) of the slide 210 (e.g., the center of the longer side of the slide 210). In some embodiments, the positioning pillars 340 are two positioning pillars and configured to efficiently secure at least one side of the slide 210. When gripping the slide 210 on the alignment device 300, the mechanical device 500 (e.g., the robotic arm 520 of the mechanical device 500) can grip the middle position (or the center) of the slide 210 between the two positioning pillars 340.

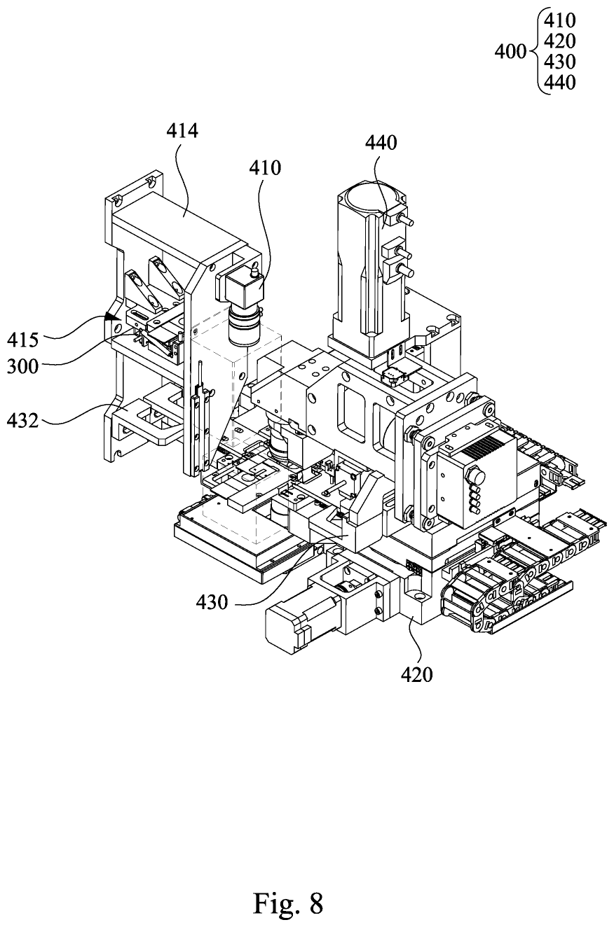

FIG. 8 is a schematic view of a scanning assembly device 400 in accordance with an embodiment of the present disclosure. Referring to FIGS. 2 and 8, the scanning assembly device 400 includes the image capturing device 410, the planar base 420, the slide compression device 430 and the optical device 440. The image capturing device 410 is adjacent to the slide cassette device 200. The image capturing device 410 includes a support element 414, in which the support element 414 defines (or has) an accommodation space 415. In some embodiments, the alignment device 300 is located in the accommodation space 415 of the support element 414 of the image capturing device 410 of the scanning assembly device 400. The slide compression device 430 is located on the planar base 420, and a first gripping structure 432 of the slide compression device 430 extends through the image capturing device 410. The first gripping structure 432 of the slide compression device 430 may has a portion located directly below the alignment device 300 (or the accommodation space 415 of the support element 414 of the image capturing device 410). The optical device 440 is located on the slide compression device 430.

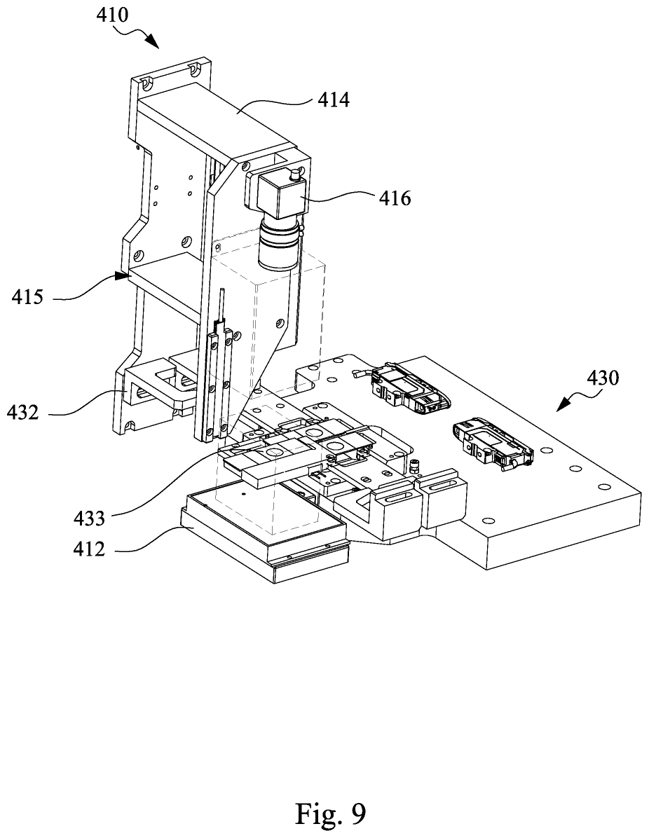

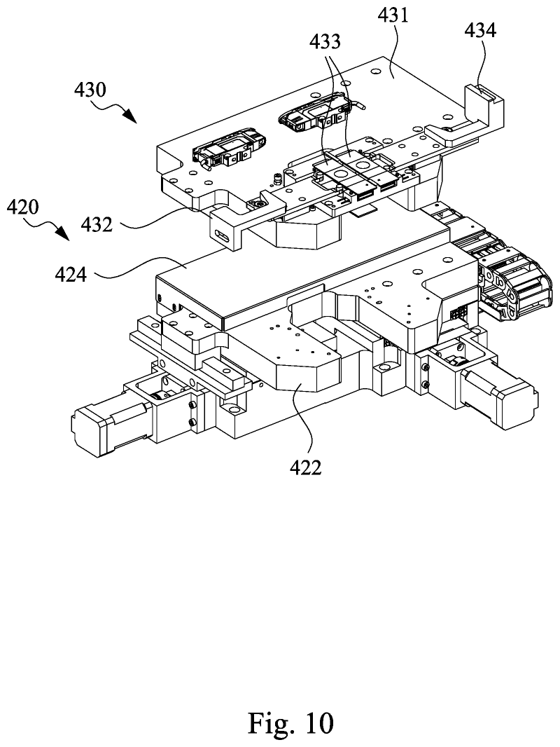

FIG. 9 is a schematic view of the image capturing device 410 and the slide compression device 430 of the scanning assembly device 400 shown in FIG. 8, and FIG. 10 is a schematic view of the slide compression device 430 and the planar base 420 of the scanning assembly device 400 shown in FIG. 8. Referring to FIGS. 2, 8, 9 and 10, the image capturing device 410 includes a base 412, the support element 414, and a camera 416. The camera 416 is located on one side of the support element 414 and is aligned to the underlying base 412. The first gripping structure 432 of the slide compression device 430 extends through the image capturing device 410. The slide compression device 430 includes a slide holder 433 connected to the first gripping structure 432. In some embodiments, the slide holder 433 consists of two slide holders, and each of them is configured to hold the slide 210. In some embodiments, the image capturing device 410 is configured to capture the image of the sample distribution area 212 (see FIG. 6) of the slide 210. Specifically, the camera 416 of the image capturing device 410 is configured to capture the image of the sample distribution area 212 (see FIG. 6) of the slide 210. In some embodiments, the camera 416 of the image capturing device 410 is further configured to capture an image of the identification area 214 (see FIG. 6) of the slide 210. In some embodiments, the camera 416 of the image capturing device 410 is configured to simultaneously capture the images of the sample distribution area 212 and the identification area 214 (see FIG. 6) of the slide 210. In some embodiments, the base 412 of the image capturing device 410 has a groove, and the groove is equipped with a light source to provide illumination when the camera 416 captures the image.

As shown in FIGS. 8 and 10, the slide compression device 430 may be located on the planar base 420. In greater details, the planar base 420 includes a base structure 422 and a cover plate 424. The base structure 422 of the planar base 420 provides a platform for placing the slide compression device 430 thereon, and the cover plate 424 covers the planar base 420. Furthermore, the slide compression device 430 includes an upper plate 431, the first gripping structure 432, the slide holder 433, and a second gripping structure 434. The upper plate 431 of the slide compression device 430 is located on the base structure 422 of the planar base 420. The first gripping structure 432, the slide holder 433, and the second gripping structure 434 are connected to the upper plate 431. The slide holder 433 is located between the first gripping structure 432 and the second gripping structure 434. In some embodiments, the slide holder 433 includes two holders configured to hold two slides 210. When the image capturing device 410 captures one slide 210 on the first holder of the slide holder 433, the robotic arm (see the robotic arm 520 in FIG. 15) can grip another slide 210 and place the another slide on the second holder of the slide holder 433. As such, time of operating procedure of the slide 210 can be saved. In some embodiments, the first gripping structure 432 and the second gripping structure 434 are configured to secure (or clamp) the slide 210 on the slide holder 433. In some embodiments, the planar base 420 and the slide compression device 430 are considered as an assembly. For example, the upper plate 431 of the slide compression device 430 is fixed to the base structure 422 of the planar base 420 through a locking mechanism (e.g., screws and screw holes), and the cover plate 424 of the planar base 420 covers the upper plate 431 of the slide compression device 430, such that the planar base 420 and the slide compression device 430 are secured with each other.

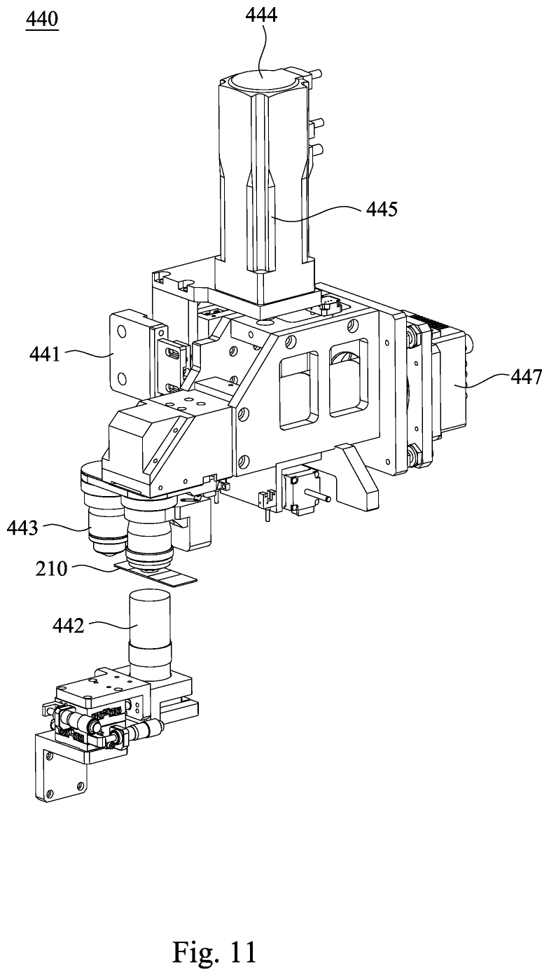

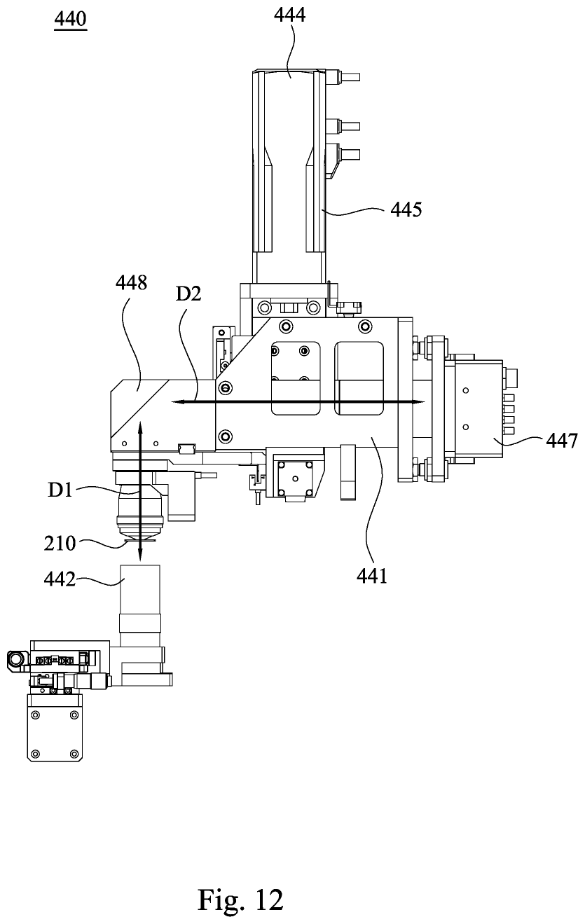

FIG. 11 is a schematic view of the optical device 440 of the scanning assembly device 400 shown in FIG. 8, and FIG. 12 is a front view of the optical device 440 of the scanning assembly device 400 shown in FIG. 11. Referring to FIGS. 8, 11, and 12, the optical device 440 includes a main body 441, a first light source 442, a microscope lens assembly 443, a visual module 444, a motor 445, a camera 447 and a prism 448. The first light source 442 is located below the main body 441, and the first light source 442 is configured to illuminate a bottom of the slide 210 during photography. The microscope lens assembly 443 is located on a bottom side of the main body 441. The microscope lens assembly 443 may include two lenses and can switch magnifications in a linear manner. The visual module 444 is located on a top side of the main body 441. The motor 445 is located on one side of the visual module 444 and is configured to move (e.g., upward or downward) an entirety of the optical device 440. The camera 447 is located on one side of the main body 441 and is configured to capture an image of the slide 210 (e.g., the sample distribution area of the slide 210) for a pathological examination operation. In some embodiments, the motor 445 drives the optical device 440 to move upward and downward, allowing the camera 447 to capture images of the slide 210 at different depths for the pathological examination operation. The prism 448 is located within the main body 441. In some embodiments, as shown in FIG. 12, a light path of the optical device 440 moves from the first light source 442 to the prism 448 along a first direction D1 (i.e., vertical direction), and then moves from the prism 448 to the camera 447 along a second direction D2 (i.e., horizontal direction), in which the first direction D1 is perpendicular to the second direction D2.

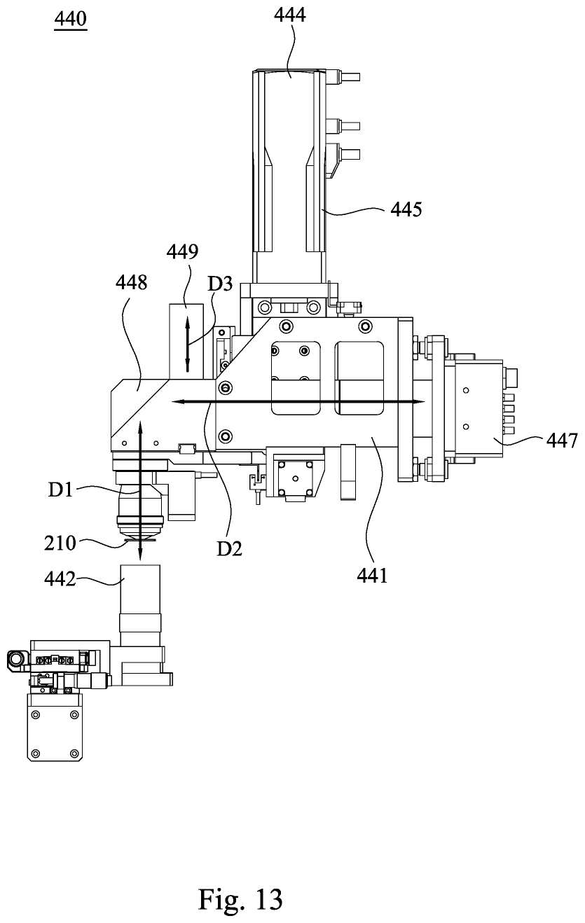

FIG. 13 is a front view of the optical device 440 of the scanning assembly device 400 in accordance with an embodiment of the present disclosure. The optical device 440 of FIG. 13 is approximately the same as the optical device 440 of FIG. 12, and the difference is the optical device 440 of FIG. 13 further includes a second light source 449. The second light source 449 may be located above the main body 441 and is configured to illuminate a top of the slide 210 during photography. In some embodiments, the second light source 449 and the first light source 442 are located on different sides of the main body 441. For example, the second light source 449 is located on the top of the main body 441, while the first light source 442 is located on the bottom of the main body 441. In some embodiments, the first light source 442 and the second light source 449 are two different light sources. For example, the first light source 442 is a bulb light source (e.g., a halogen bulb light source), while the second light source 449 is a fluorescent light source. As shown in FIG. 13, a light path of the optical device 440 includes a first light path corresponding to the first light source 442 and a second light path corresponding to the second light source 449. The first light path includes a path from the first light source 442 to the prism 448 along a first direction D1 and a path from the prism 448 to the camera 447 along a second direction D2, in which the first direction D1 is perpendicular to the second direction D2. The second light path includes a path from the second light source 449 to the prism 448 along a third direction D3 and a path from the prism 448 to the camera 447 along the second direction D2, in which the third direction D3 is perpendicular to the second direction D2 and parallel to the first direction D1. Since the first light source 442 and the second light source 449 are superimposed on the camera 447 along the second direction D2, the image of the slide 210 captured by the camera 447 can be clearer.

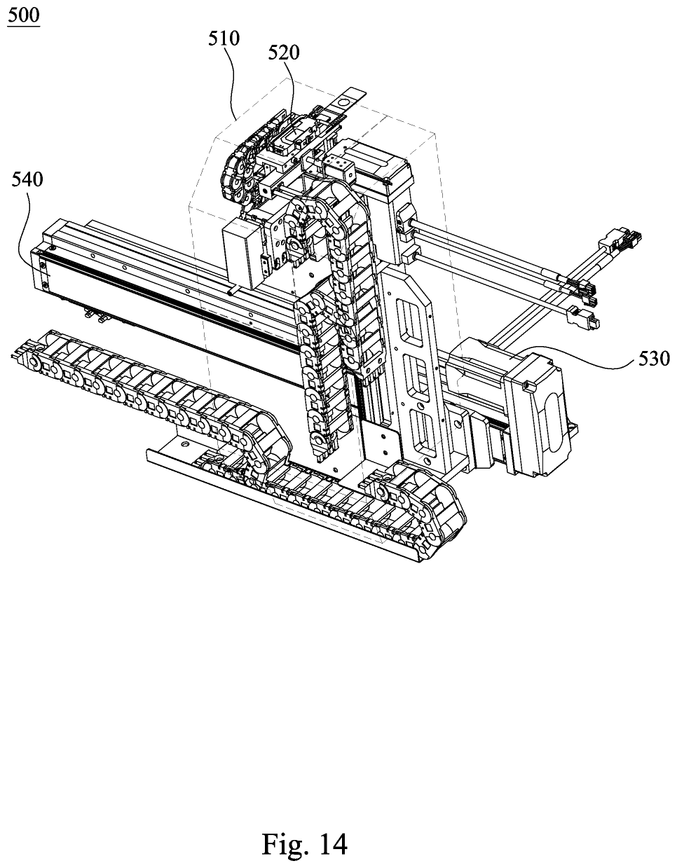

FIG. 14 is a schematic view of a mechanical device 500 in accordance with an embodiment of the present disclosure, and FIG. 15 is a partially enlarged view of the robotic arm 520 of the mechanical device 500 in FIG. 14. Referring to FIGS. 2, 14, and 15, the mechanical device 500 includes a housing 510, the robotic arm 520, a motor 530, and a guide rail 540. The robotic arm 520 is located within the housing 510 and is configured to move the slide 210 (e.g., from the slide cassette device 200 to the image capturing device 410). The motor 530 is configured to drive the robotic arm 520 to move along the guide rail 540. It is noted that the housing 510 is illustrated as dashed lines in FIG. 14 to highlight an internal structure (e.g., robotic arm 520) inside the housing 510 for clarity.

The robotic arm 520 includes a first movable arm 522, a second movable arm 524, a gripper connector 525, a gripper 526 and a slide holder 528. The second movable arm 524 is located on the first movable arm 522, and the second movable arm 524 is connected to the first movable arm 522. The first movable arm 522 and the second movable arm 524 are configured to control movement distance of the robotic arm 520. For example, the first movable arm 522 is configured to control the movement of the robotic arm 520 for a greater distance (e.g., from the image capturing device 410 to the slide cassette device 200), while the second movable arm 524 is configured to control the movement of the robotic arm 520 for a smaller distance (e.g., between different slide cassettes in the slide cassette device 200). The gripper connector 525 is located on the second movable arm 524 and is configured to hold the gripper 526. The gripper 526 is configured to grip the slide 210. The slide holder 528 is located below the gripper 526 and is configured to hold the slide 210. In some embodiments, the robotic arm 520 further includes two detectors 529 located on two opposite sides of the slide holder 528. The detectors 529 are configured to detect the location of the slide 210 in the slide cassette device 200. Furthermore, the detectors 529 may be configured to detect the number of slides 210 on the slide holder 528. In some embodiments, as shown in FIGS. 2-5, 14 and 15, if the slide 210 is determined to be in the defective state by the processor 600, the robotic arm 520 is configured to place the slide 210 in the second region A2 of the slide cassette device 200 different from the first region A1 of the slide cassette device 200; if the slide 210 is determined not to be in the defective state by the processor 600, the robotic arm 520 is configured to place the slide 210 back in the first region A1 of the slide cassette device 200.

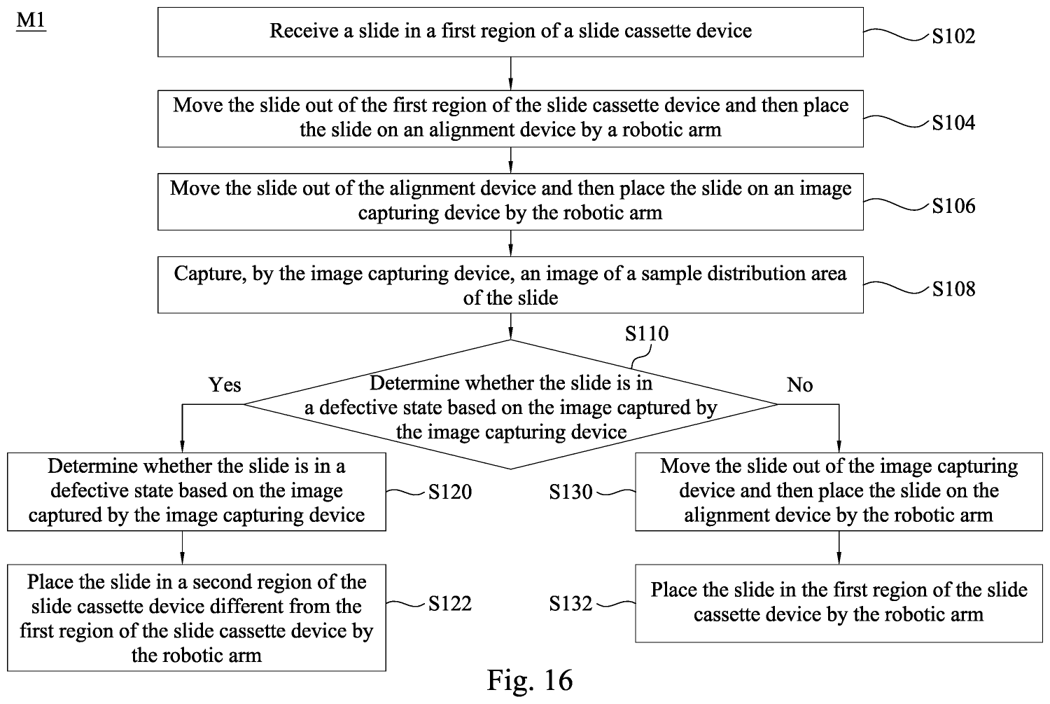

To summarize the operation of the slide information capturing and evaluation device 10 in accordance with an embodiment of the present disclosure, refer to FIG. 16. FIG. 16 is a flowchart of a method M1 of operating the slide information capturing and evaluation device in accordance with an embodiment of the present disclosure, in which the method M1 includes steps S102 to S132. It is understood that additional operations may be provided before, during, and after the steps shown by FIG. 16, and some of the steps described below can be replaced or eliminated for additional embodiments of the method M1. The order of the operations/processes may be interchangeable.

The method M1 begins at step S102, where a slide is received in a first region of a slide cassette device. Referring to FIG. 2, in some embodiments of step S102, the slide 210 is received in the first region A1 of the slide cassette device 200.

The method M1 then proceeds to step S104, where the slide is moved out of the first region of the slide cassette device and then the slide is placed on an alignment device by a robotic arm. Referring to FIGS. 2-5, 7, 14 and 15, in some embodiments of step S104, the slide 210 is moved out of the first region A1 of the slide cassette device 200 and then the slide 210 is placed on the alignment device 300 by using the robotic arm 520. In greater details, the processor 600 provides a first control signal that enables the robotic arm 520 to move the slide 210 from the first region A1 of the slide cassette device 200 to the alignment device 300. In some embodiments, the alignment device 300 is configured to align (or guide) the slide 210. For example, the positioning pillars 340 of the alignment device 300 can secure (or position) the slide 210.

The method M1 then proceeds to step S106, where the slide is moved out of the alignment device and then the slide is placed on an image capturing device by the robotic arm. Referring to FIGS. 2, 7-9, 14 and 15, in some embodiments of step S106, the slide 210 is moved out of the alignment device 300 and then the slide 210 is placed on the image capturing device 410 by using the robotic arm 520. In greater details, the processor 600 provides a second control signal that enables the robotic arm 520 to move the slide 210 from the alignment device 300 to the image capturing device 410. In some embodiments, the positioning pillars 340 of the alignment device 300 can secure (or positon) the slide 210, such that the robotic arm 520 of the mechanical device 500 may grip the slide 210 at the middle position (or the center) to avoid the slide 210 from dropping before being placed on the image capturing device 410.

The method M1 then proceeds to step S108, where an image of a sample distribution area of the slide is captured by the image capturing device. Referring to FIGS. 2, 6, 8, and 9, in some embodiments of step S108, the image of the sample distribution area 212 of the slide 210 is captured by the image capturing device 410. In some embodiments, the camera 416 of the image capturing device 410 is configured to capture the image of the sample distribution area 212 of the slide 210. Furthermore, the camera 416 of the image capturing device 410 is configured to capture the image of the identification area 214 of the slide 210. In some embodiments, the camera 416 of the image capturing device 410 is configured to simultaneously capture the image of the sample distribution area 212 and the identification area 214 of the same slide 210.

The method M1 then proceeds to step S110, where the slide is determined whether in a defective state based on the image captured by the image capturing device. Referring to FIGS. 2, 3, 6, 8, and 9, in some embodiments of step S110, the processor 600 is configured to determine whether the slide 210 is in the defective state based on the image captured by the image capturing device 410. In some embodiments, the step of determining whether the slide 210 is in the defective state by the processor 600 includes analyzing the image captured by the image capturing device 410 to calculate a sample indicator value and comparing the sample indicator value with a predetermined indicator value. If the sample indicator value is smaller than the predetermined indicator value, the slide 210 is determined to be in the defective state. If the sample indicator value is greater than or equal to the predetermined indicator value, the slide 210 is determined not to be in the defective state. In some embodiments, the step of determining whether the slide 210 is in the defective state by the processor 600 includes converting the image captured by the image capturing device 410 into digital information, calculating the sample indicator value by using an evaluation function, and comparing the sample indicator value with the predetermined indicator value to determine whether the slide 210 is in the defective state. The evaluation function may be, for example, a contrast transfer function (CTF). The processor 600 may be configured to select a plurality of points from the captured image, convert each point into a value (e.g., grayscale value), and then take a maximum value (e.g., maximum grayscale value) and a minimum value (e.g., minimum grayscale value) of the points to calculate the sample indicator value by using the evaluation function. In some embodiments where the evaluation function is the CTF function, the sample indicator value is represented by the following equation (I), where CTFₛ represents the sample indicator value, Max_{G} represents the maximum grayscale value, and Min_{G} represents the minimum grayscale value.

$${CTF}_{s} = \frac{{Max}_{G} - {Min}_{G}}{{Max}_{G} + {Min}_{G}} \qquad ( I )$$

Furthermore, the processor 600 is configured to compare the sample indicator value with the predetermined indicator value. For example, the predetermined indicator value can be set as a value less than 1 (e.g., 0.3, 0.4, 0.5, 0.6, 0.7, 0.8, 0.9, or other values). If the sample indicator value is greater than or equal to the aforementioned predetermined indicator value, the slide 210 is determined not to be in the defective state. If the sample indicator value is smaller than the aforementioned predetermined indicator value, the slide 210 is determined to be in the defective state. In other words, if the sample indicator value of the captured image is greater than or equal to the predetermined indicator value, the quality of the captured image meets the requirements for pathological examination (i.e., the slide 210 is not in the defective state). In some embodiments, if the processor 600 determines that the slide 210 is in the defective state, the processor 600 may issue a warning message to notify relevant personnel.

If step S110 is yes (i.e., the slide 210 is in the defective state), then method M1 then proceeds to step S120, where the slide is moved out of the image capturing device and then the slide is placed on the alignment device by the robotic arm. Referring to FIGS. 2-5 and 7-9, in some embodiments of step S120, the slide 210 is moved out of the image capturing device 410 and then the slide 210 is placed on the alignment device 300 by using the robotic arm 520. In greater details, the processor 600 provides a third control signal that enables the robotic arm 520 to move the slide 210 from the image capturing device 410 to the alignment device 300. In some embodiments, the alignment device 300 is configured to align the slide 210 before the slide 210 is placed in the slide cassette device 200 by using the robotic arm 520.

After step S120, the method M1 then proceeds to step S122, where the slide is placed in a second region of the slide cassette device different from the first region of the slide cassette device by the robotic arm. Referring to FIGS. 2-5, in some embodiments of step S122, the slide 210 is placed in a second region A2 of the slide cassette device 200 different from the first region A1 of the slide cassette device 200 by using the robotic arm 520. In greater details, the processor 600 provides a fourth control signal that enables the robotic arm 520 to move the slide 210 from the alignment device 300 to the second region A2 of the slide cassette device 200. In some embodiments, the positioning pillars 340 of the alignment device 300 can secure (or position) the slide 210, such that the robotic arm 520 of the mechanical device 500 may grip the slide 210 at the middle position (or the center) to avoid the slide 210 from dropping before being placed in the second region A2 of the slide cassette device 200. In some embodiments, the slide cassettes 230 are located in the second region A2 of the slide cassette device 200 and are configured to receive the slide 210 in the defective state. In some embodiments, after step S122, an image analysis operation is performed. In greater details, if the slide 210 is determined not to be in the defective state, the slide 210 is placed on the optical device 440 for pathological examination by using the robotic arm 520. For example, the image of the slide is captured by the camera 447 of the optical device 440, and captured image is analyzed by the processor 600.

If step S110 is no (i.e., the slide 210 is not in the defective state), the method proceeds to step S130, where the slide is moved out of the image capturing device and then the slide is placed on the alignment device by the robotic arm. Referring to FIGS. 2-5 and 7-9, in some embodiments of step S130, the slide 210 is moved out of the image capturing device 410 and then the slide 210 is placed on the alignment device 300 by using the robotic arm 520. In greater details, the processor 600 provides a fifth control signal that enables the robotic arm 520 to move the slide 210 from the image capturing device 410 to the alignment device 300. The fifth control signal is substantially equal to the third control signal. In some embodiments, the alignment device 300 is configured to align the slide 210 before the slide 210 is placed in the slide cassette device 200 by using the robotic arm 520.

After step S130, the method M1 then proceeds to step S132, where the slide is placed in the first region of the slide cassette device by the robotic arm. Referring to FIGS. 2-5, in some embodiments of step S132, the slide 210 is placed in the first region A1 of the slide cassette device 200 by using the robotic arm 520. In greater details, the processor 600 provides a sixth control signal that enables the robotic arm 520 to move the slide 210 from the alignment device 300 to the first region A1 of the slide cassette device 200. In some embodiments, the positioning pillars 340 of the alignment device 300 can secure (or position) the slide 210, such that the robotic arm 520 of the mechanical device 500 may grip the slide 210 at the middle position (or the center) to avoid the slide 210 from dropping before being placed in the first region A1 of the slide cassette device 200. In some embodiments, the robotic arm 520 places the slide 210 back in the original region (step S104). For example, the slide 210 is placed back to the original location in the first region A1 in the slide cassette 220.

In summary, since the image capturing device of the slide information capturing and evaluation device is configured to capture the image of the sample distribution area of the slide, and the processor is configured to determine whether the slide is in the defective state based on the image captured by the image capturing device, it is beneficial to categorize the slide in the defective state and not in the defective state before performing subsequent pathological examination (e.g., analysis procedures using the optical device). Therefore, the slide information capturing and evaluation device of the present disclosure can transfer the physical slide into digital information and effectively improve the accuracy of the subsequent pathological examination.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method of operating a slide information capturing and evaluation device, comprising:
receiving a slide in a first region of a slide cassette device;
moving the slide out of the first region of the slide cassette device and placing the slide on an alignment device by a robotic arm;
moving the slide out of the alignment device and placing the slide on an image capturing device by the robotic arm;
capturing an image of a sample distribution area of the slide by the image capturing device; and
determining whether the slide is in a defective state based on the image captured by the image capturing device.

2. The method of claim 1, further comprising:
placing the slide in a second region of the slide cassette device different from the first region by the robotic arm if the slide is determined to be in the defective state.

3. The method of claim 2, further comprising:
prior to placing the slide in the second region of the slide cassette device by the robotic arm, moving the slide out of the image capturing device and placing the slide on the alignment device by the robotic arm.

4. The method of claim 1, further comprising:
placing the slide in the first region of the slide cassette device by the robotic arm if the slide is determined not to be in the defective state.

5. The method of claim 1, further comprising:
prior to placing the slide in the first region of the slide cassette device by the robotic arm, moving the slide out of the image capturing device and placing the slide on the alignment device by the robotic arm.

6. The method of claim 1, wherein determining whether the slide is in the defective state comprises:
analyzing the image captured by the image capturing device to calculate a sample indicator value; and
comparing the sample indicator value with a predetermined indicator value, wherein if the sample indicator value is smaller than the predetermined indicator value, the slide is determined to be in the defective state, and if the sample indicator value is greater than or equal to the predetermined indicator value, the slide is determined not to be in the defective state.

7. The method of claim 1, wherein the image capturing device comprises a support element, the support element has an accommodation space, and the alignment device is disposed in the accommodation space of the support element of the image capturing device.

8. A method of operating a slide information capturing and evaluation device, comprising:
receiving a slide in a first region of a slide cassette device;
placing the slide on an image capturing device by a robotic arm;
capturing an image of a sample distribution area of the slide by the image capturing device; and
determining whether the slide is in a defective state based on the image captured by the image capturing device, wherein placing the slide in the first region of the slide cassette device by the robotic arm if the slide is determined not to be in the defective state, and wherein placing the slide in a second region of the slide cassette device different from the first region by the robotic arm if the slide is determined to be in the defective state.

9. The method of claim 8, further comprising:
placing the slide on an alignment device by the robotic arm such that a protrusion portion of a slide holder and positioning pillars of the alignment device are respectively against two opposite sides of the slide.

10. The method of claim 9, wherein placing the slide on the alignment device is performed prior to placing the slide on the image capturing device.

11. The method of claim 9, wherein placing the slide on the alignment device is performed after placing the slide on the image capturing device.

12. The method of claim 8, further comprising:
issuing a warning message if the slide is determined to be in the defective state.

13. The method of claim 8, further comprising:
capturing an image of an identification area of the slide by the image capturing device.

14. A slide information capturing and evaluation device, comprising:
a slide cassette device configured to receive a slide in a first region of the slide cassette device;
a scanning assembly device comprising an image capturing device adjacent to the slide cassette device, wherein the image capturing device is configured to capture an image of a sample distribution area of the slide;
a processor communicatively connected to the image capturing device of the scanning assembly device and configured to determine whether the slide is in a defective state based on the image captured by the image capturing device; and
a mechanical device communicatively connected to the processor, wherein the mechanical device comprises a robotic arm configured to move the slide from the slide cassette device to the image capturing device.

15. The slide information capturing and evaluation device of claim 14, further comprising:
an alignment device disposed in an accommodation space of a support element of the image capturing device of the scanning assembly device, wherein the alignment device is configured to position the slide prior to capturing the image of the sample distribution area of the slide.

16. The slide information capturing and evaluation device of claim 15, wherein the alignment device is further configured to position the slide after capturing the image of the sample distribution area of the slide.

17. The slide information capturing and evaluation device of claim 15, wherein the alignment device comprises a slide holder and a positioning pillar, and a protrusion portion of the slide holder and the positioning pillar are respectively against two opposite sides of the slide.

18. The slide information capturing and evaluation device of claim 15, wherein the robotic arm is configured to place the slide in a second region of the slide cassette device different from the first region if the slide is determined to be in the defective state.

19. The slide information capturing and evaluation device of claim 15, wherein the robotic arm is configured to place the slide in the first region of the slide cassette device if the slide is determined not to be in the defective state.

20. The slide information capturing and evaluation device of claim 15, wherein the robotic arm comprises a slide holder and a detector disposed on the slide holder, the slide holder of the robotic arm is configured to hold the slide, and the detector is configured to detect a location of the slide in the slide cassette device.
